(19) United States
(12) Patent Application Publication
(10) Pub. No.: US 2020/0011767 A1
(43) Pub. Date: Jan. 9, 2020

(54) Reciprocating Microtome

(71) Applicant: Precisionary Instruments LLC, Winchester, MA (US)

(72) Inventors: Laura Fleury, Newton, MA (US); David Elentukh, Brighton, MA (US)

(21) Appl. No.: 16/029,300

(22) Filed: Jul. 6, 2018

(51) Int. Cl. G01N 1/06

(52) U.S. Cl. CPC G01N 1/06; G01N 2001/061; G01N 2001/065

(57) ABSTRACT

A microtome for cutting fresh tissue slices from a specimen directs a reciprocating blade along a slicing path such that a cutting edge of the blade traverses a slicing window at an angle that is preferably perpendicular, or near perpendicular, to the slicing path. A blade drive motor drives the cutting edge of the blade in a reciprocating motion, in a longitudinal direction, via an eccentric coupled to a blade holder by a rigid link. Preferred embodiments include a specimen actuator disposed to urge the specimen into the slicing window, and a slidably-removable buffer tray disposed to receive a tissue slice cut from the specimen.

### TECHNICAL FIELD

The present invention relates to tissue slicers, and more particularly to vibrating microtomes.

### BACKGROUND ART

Microtomes are used to slice tissue for biomedical examination. Vibrating blade microtomes are known to cut soft tissue slices without the need for tissue embedding or freezing.

### SUMMARY OF THE EMBODIMENTS

A first embodiment is an apparatus for cutting a slice from a specimen with a blade having a longitudinal blade edge. The apparatus includes a base defining a plane, and several components supported by the base, which components cooperate to slice the specimen. The components include a blade holder movably mounted to the base so as to move the blade along a slicing path. In preferred embodiments, the slicing path is diagonal relative to the plane. The apparatus also includes a drive motor operably coupled to the blade holder to drive the blade holder along the slicing path.

The blade holder is disposed such that the longitudinal blade edge forms, relative to the plane, a non-zero angle. For example, in some embodiments, the blade holder is disposed such that the blade edge forms, relative to the plane, an angle of at least 30 degrees. In some embodiments, the blade holder is disposed such that the blade edge forms, relative to the slicing path, an angle between 45 and 90 degrees.

The apparatus also includes a buffer tray attached to the base and disposed to receive slices cut from the specimen by the blade. In illustrative embodiments, the buffer tray is removably attached to the base, and in preferred embodiments the buffer tray is slidably attached to the base, for example by cooperating mating features, such as a tray rail and fastener system.

Another embodiment of an apparatus for cutting a slice from a specimen, using a blade having a longitudinal blade edge, includes a base defining a plane, and a blade holder movably mounted to the base so as to move the blade along a slicing path. In preferred embodiments, the slicing path is diagonal relative to the plane.

The apparatus also includes a blade drive system operably coupled to the blade holder, such that the blade drive system is configured to drive the longitudinal edge of the blade in a reciprocating motion. In illustrative embodiments, the blade drive system includes a blade drive motor and an eccentric rotatably coupled to the blade drive motor. A rigid link couples the eccentric and the blade holder to transform rotary motion of the eccentric to reciprocating motion of the blade holder. In preferred embodiments, the rigid link is a rigid plastic link.

Some embodiments of the apparatuses described above also include a specimen actuator disposed to urge the specimen into a slicing window of the apparatus. In preferred embodiments, the specimen actuator is fixed to the base of the apparatus.

Some embodiments of the apparatuses described above include a control box fixed to the base, and housing a control system. The control system coordinates the motions of the moving parts of the apparatus, including the slide rail and blade. More specifically, the control system is operably coupled to various motors that cause the motion of such moving parts.

A method of operating a microtome includes providing a microtome having a base, the base having a cutting arm movably coupled to the base, and a blade holder coupled to the cutting arm, the blade holder configured to hold a cutting blade having a cutting edge. The method includes providing a specimen extending through a slicing window, and then moving the cutting edge in a longitudinal reciprocating motion; and moving the cutting arm along a slicing path such that the blade traverses a slicing window, thereby cutting a slice from the specimen. Some embodiments also include, after moving the cutting arm along the slicing path, retracting the slicing arm and advancing a face of the specimen into the slicing window, to prepare the microtome and specimen to produce a subsequent slice from the specimen.

### BRIEF DESCRIPTION OF THE DRAWINGS

The foregoing features of embodiments will be more readily understood by reference to the following detailed description, taken with reference to the accompanying drawings, in which:

FIG. 1A and FIG. 1B schematically illustrate an embodiment of a microtome;

FIG. 1C schematically illustrates an embodiment of a an arm slide rail;

FIG. 1D schematically illustrates an embodiment of a specimen driver;

FIG. 1E, FIG. 1F and FIG. 1G schematically illustrate, respectively, shapes of cross-sections of embodiments of a tray rail;

FIG. 2 schematically illustrates an embodiment of a buffer tray;

FIG. 3A and FIG. 3B schematically illustrate an embodiment of a blade drive system;

FIG. 4A schematically illustrates embodiment of a blade assembly;

FIG. 4B schematically illustrates an embodiment of a blade approach angle;

FIG. 5 schematically illustrates a microtome at different points in time, in executing a slicing operation;

FIG. 6 schematically illustrates an embodiment of a control system;

FIG. 7 schematically illustrates an embodiment of a process of slicing a specimen.

### DETAILED DESCRIPTION OF SPECIFIC EMBODIMENTS

Embodiments described herein increase the efficiency of a microtome by enabling the microtome to cut a larger slice of a specimen with a given cutting blade than possible with prior art devices having a blade of the same size. Preferred embodiments drive a cutting blade to reciprocate along its longitudinal edge, and direct the reciprocating blade along a slicing path such that a cutting edge of a blade traverses a slicing window at an angle that is preferably perpendicular, or near perpendicular, to the slicing path.

Some embodiments drive the blade with blade drive motor via an eccentric coupled to a blade holder by a rigid link. As compared to prior art devices, a rigid link reduces undesirable vibrations in the motion of the cutting blade.

Illustrative embodiments include a specimen actuator disposed to urge the specimen into the slicing window. In preferred embodiments, the actuator is mounted to a base to have a fixed position relative to the cutting region, so as to improve the registration of the specimen to the cutting region relative to prior art devices.

Some embodiments include a slidably-removable buffer tray disposed to receive a tissue slice cut from the specimen. The removable buffer tray makes it easier for an operator to retrieve a slice captured by the buffer tray, and also makes it easier to clean and/or replace a buffer tray, relative to a slicer having a fixed slice capturing structure. For example, in operation, after slicing a first specimen, the buffer tray may be removed and replaced with a second buffer tray so that the slices from the first specimen may be removed while the microtome continues in operation using the second buffer tray. Thus, the ability to remove the buffer tray increases the efficiency of the microtome by increasing, relative to a slicer having a fixed slice capturing structure, the quantity of time that the microtome is able to be used.

Definitions. As used in this description and the accompanying claims, the following terms shall have the meanings indicated, unless the context otherwise requires:

A blade edge reciprocates “longitudinally” when the edge reciprocates along its length.

A “slice” is a portion of a specimen after the portion has been cut from the specimen.

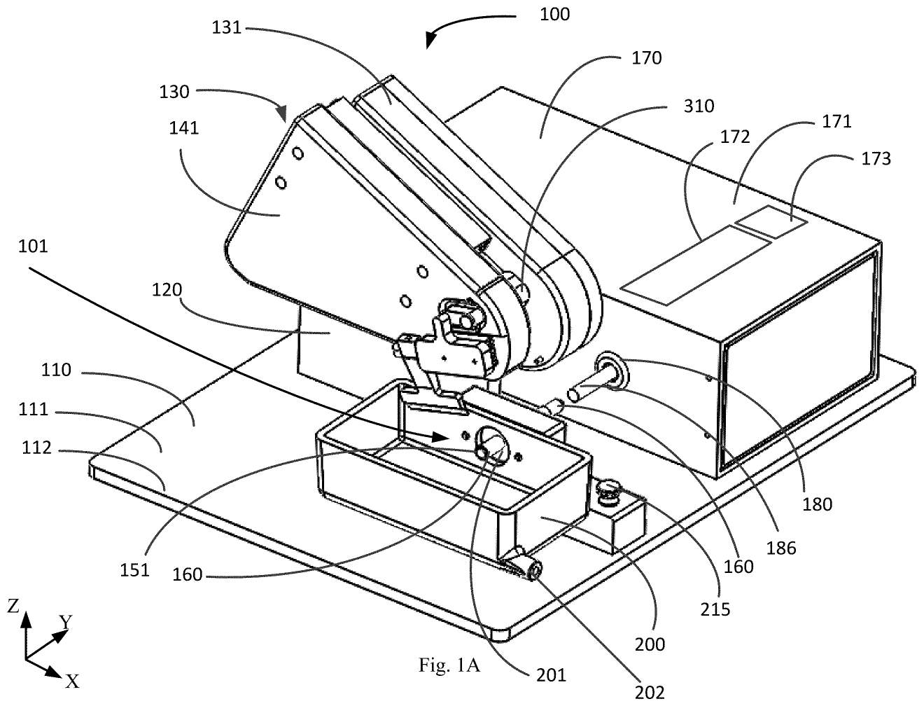

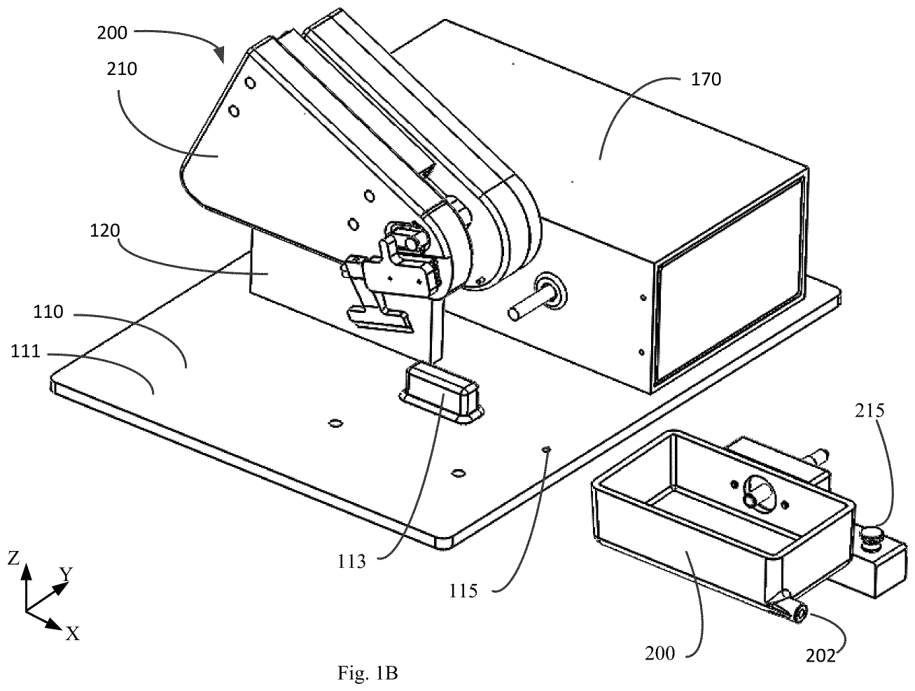

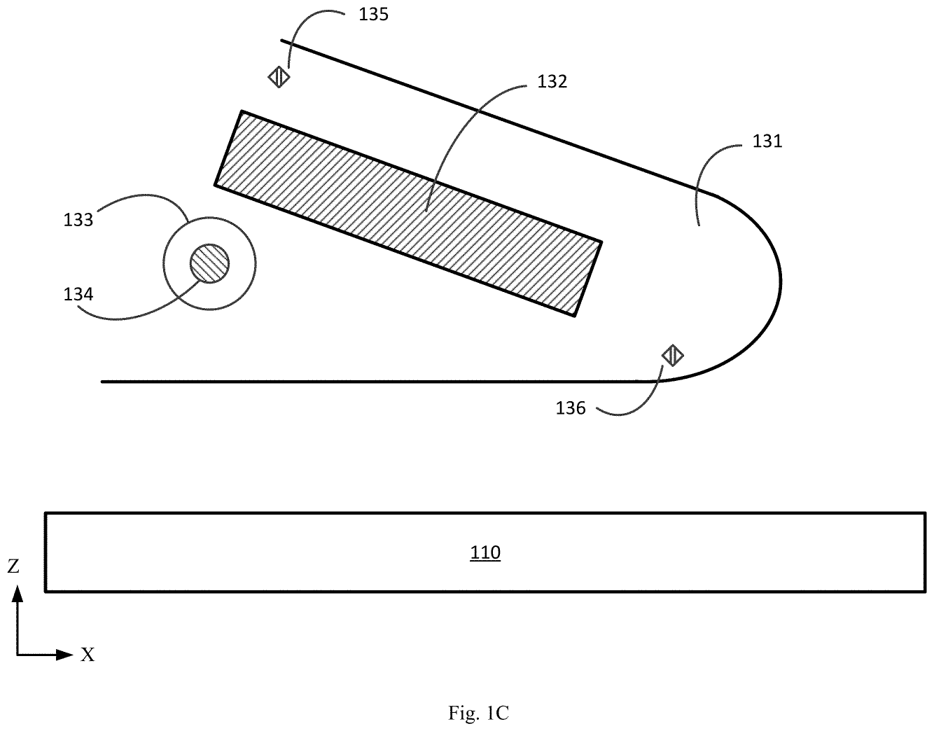

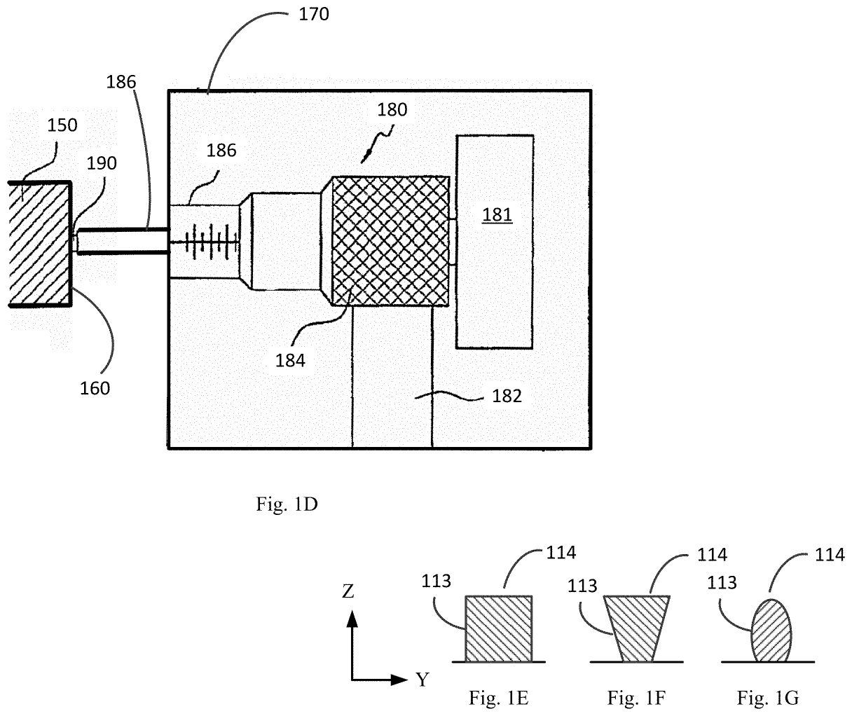

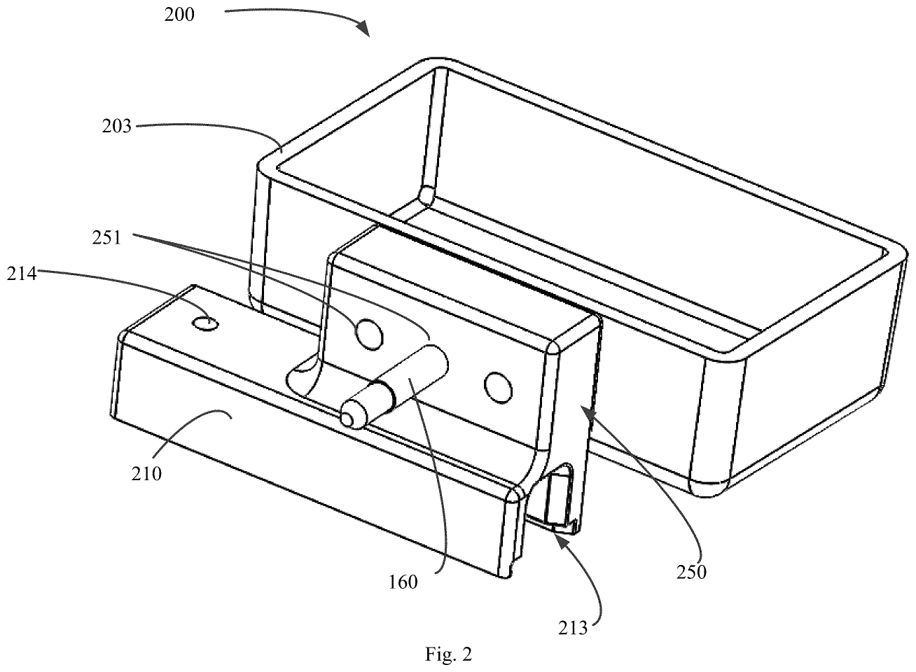

FIG. 1 schematically illustrates a microtome 100 according to a first embodiment. The microtome 100 has a base 110 that supports, from its top surface 111, structures that cooperate to cut a slice 152 from the face 151 of a specimen 150. The base 110 also defines a plane 112, which in FIG. 1A is parallel to the plane defined by the X-Y axes.

A superstructure 120 extends from the base 110 and suspends a slicer assembly 130 above the base 110. The slicer assembly includes a slicer arm 141 movably coupled to the superstructure 120. In the embodiment of FIG. 1A, the superstructure 120 includes an arm support plate 131 to which the slicer arm 141 is movably coupled.

The slicer assembly 130 also includes a blade holder 360 and blade driver system, described in more detail below, to hold and drive a cutting blade 105 to cut a slice 152 from a specimen 150.

The microtome 100 also includes a control box 170, preferably fixed to the base 110. The control box 170 houses a control system 600, configured to control and coordinate the operations of the moving features (e.g., motors, sliding arm; blade holder and blade) of the microtome 100. To that end, the control box 170 may include an operator interface 171, which operator interface may include a display 172 and one or more controls 173 that can be manipulated by an operator to control the microtome 100. Such controls 173, which may be referred to as operator-manipulatable controls, may include buttons, knobs, and switches, to name but a few examples. In preferred embodiments, the control box 170 is fixed to the base 110.

FIG. 1C schematically illustrates an embodiment of an arm guide apparatus, which apparatus includes a diagonal slide rail 132 affixed to arm support plate 131.

The slicer arm 141 is supported for diagonal movement along the slide rail 132. In operation, the slicer arm 141 is operably coupled to arm drive motor 133, for example by pinion 134, and urges the slicer arm 141 down the diagonal slide rail 132 to slice the specimen 150, and then back up the diagonal slide rail 132 to prepare for a subsequent slicing operation. To that end, preferred embodiments of the slide rail 132 have friction reducing components, such as linear bearings, low friction slide surfaces or the like so that the slicer arm 141 slides easily along the slide rail 132.

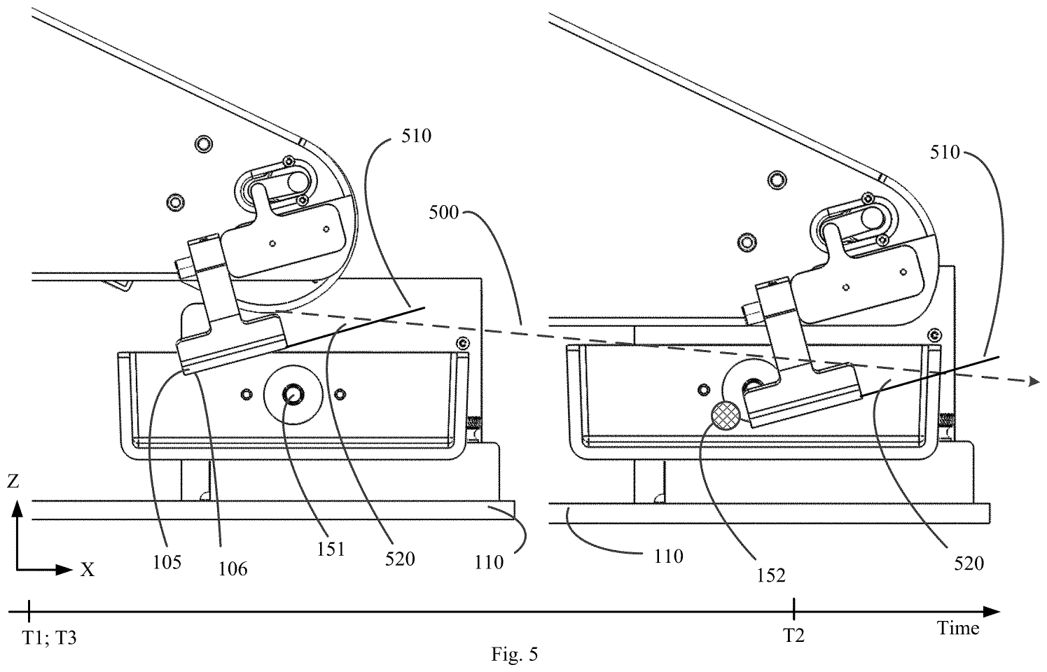

Preferred embodiments also include a sensor system in communication with control system 600, to monitor the motion of the slicing arm 141, and its position along the slide rail 132. For example, preferred embodiments include a bottom sensor 136 disposed to detect the slicing arm 141 at the end of its motion along a slicing path 500 (e.g., at time T2 in FIG. 5), at which point the slicing arm is in position to retract back to the top of the diagonal slide rail 132 (e.g., at time T3 in FIG. 5). Illustrative embodiments include a top sensor 135 disposed to detect the slicing arm 141 after it has retracted to the top of the diagonal slide rail 132, at which point the slicing arm 141 is positioned to begin a subsequent slicing motion.

The top sensor 135 and bottom sensor 136 may be any sensor suitable to detect the slide arm 141 as described above. For example, in illustrative embodiments the slide arm 141 includes one or more magnets, and the sensors 135 and 136 are Hall Effect sensors. In other embodiments, each of the sensors 135 and 136 is an optical sensor that detects a change in ambient light when the slide arm 141 moves past. In other embodiments, at least one of the sensors 135 and 136 is a switch that is disposed to be tripped by the sliding arm 141 as it passes.

In other embodiments, the arm drive motor 133 is a reversible motor, the position of which can be read by the controller 600, to ascertain the position of the slicing arm 141 along the slide rail 132. In such embodiments, the controller 600 controls the arm drive motor 133 to move the slicing arm 141 down the slide rail 132 to a position known, to the controller 600, to be the bottom of the slicing path. Then, the controller 600 controls the arm drive motor 133 to retract the slicing arm.

FIG. 1D schematically illustrates an embodiment of a specimen actuator system 180. The specimen actuator system 180 controllably urges the face 151 of the specimen 150 into the slicing window 101. To that end, the specimen actuator system 180 includes a micrometer 184 suspended within control box 170 by a support pedestal 182. The micrometer 184 is coupled to a specimen drive motor 181 which, in preferred embodiments, is controlled by control system 600 described below.

The micrometer 184 includes an extendable specimen actuator shaft (or “plunger”) 186 that extends in the direction of the specimen holder 160 when turned in a first direction by the specimen drive motor 181, and retracts when turned in the opposite direction by the specimen drive motor 181. The distal end 190 of the plunger 186 contacts the specimen holder 160 to urge the specimen holder 160, and the specimen 150 that it holds, towards the slicing window 101 of the microtome 100, to position the specimen 150 to be sliced by the blade 105.

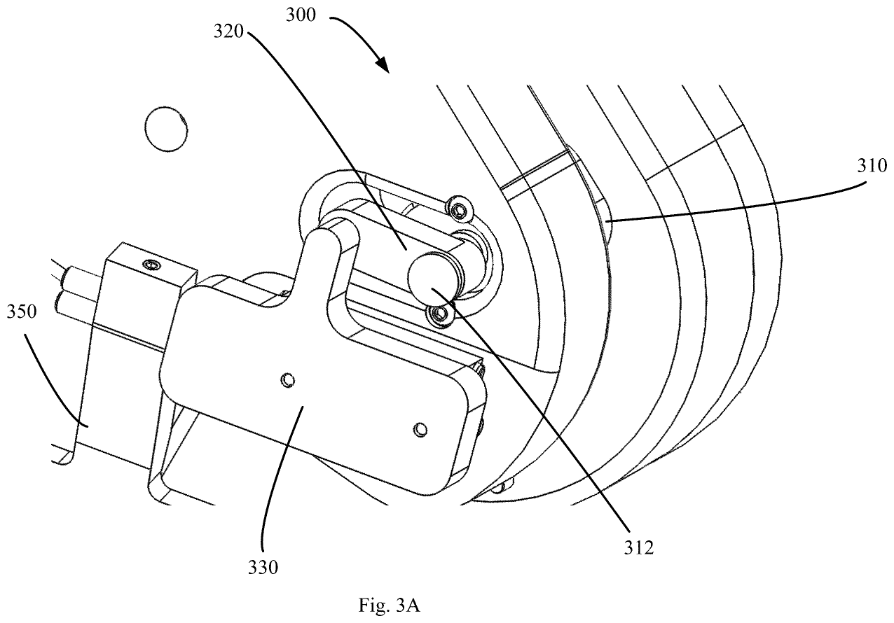

The microtome 100 includes a buffer tray assembly 200 disposed to capture slices from the specimen 150. FIG. 1A schematically illustrates an embodiment of a buffer tray assembly 200 disposed on the base 110 of the microtome 100, and FIG. 2 schematically illustrates the buffer tray assembly 200.

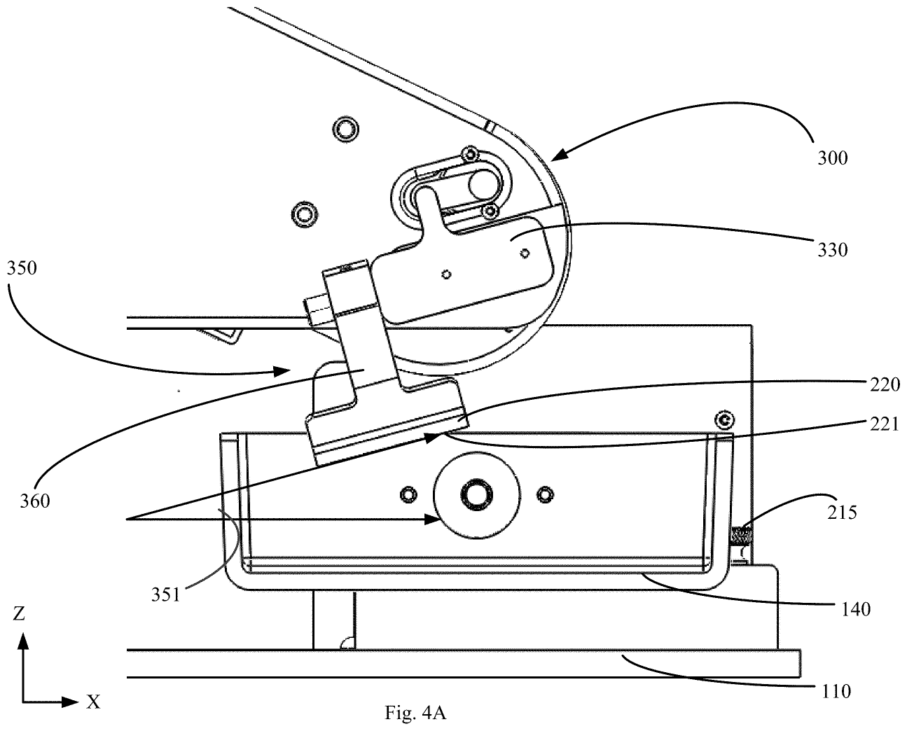

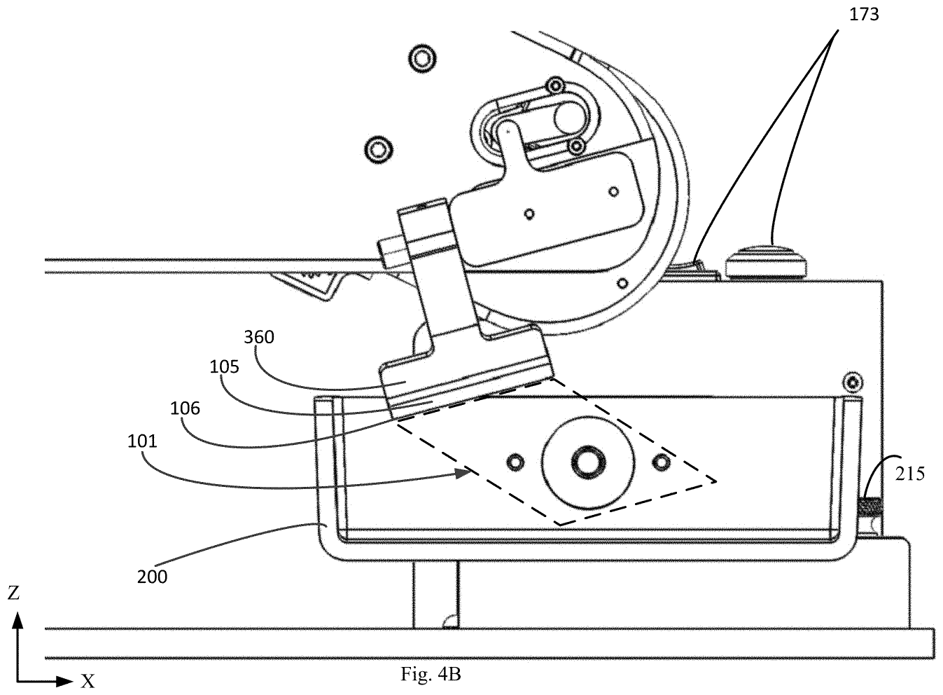

The buffer tray assembly 200 includes a receptacle 203 shaped to receive and hold a slice 152 severed from a specimen 150. For example, in the embodiment of FIG. 2, the receptacle 203 has the shape of a tub. The receptacle 203 includes a specimen aperture 201, through which the specimen holder protrudes to deliver and hold the face 151 of the specimen 150 in a slicing window 101 (an embodiment of a slicing window 101 is schematically illustrated in FIG. 4B, and shows the face 151 of a specimen 150).

The buffer tray assembly 200 also includes a specimen block 250 disposed adjacent to the specimen aperture 201, to secure the specimen holder 160 in position such that the specimen holder is disposed to engage the distal end 190 of the plunger 186, and to hold the specimen 150 through the specimen aperture 201. To that end, the specimen block 250 includes at least one retaining aperture 251 shaped to receive and slidably retain the specimen holder 160. FIG. 2 schematically illustrates a specimen holder 160 within a retaining aperture 251. In general the retaining aperture 251 is sized to hold the specimen holder 160 snugly, so that the retaining aperture 251 holds the specimen 150 steady as the microtome 100 cuts a slice 152 from the specimen 150, but the retaining aperture 251 also allows the specimen holder 160 to advance through the retaining aperture 251 when urged to do so by the plunger 186.

In preferred embodiments, the buffer tray assembly 200 is easily removable from the base 110. FIG. 1B schematically illustrates the buffer tray assembly 200 separated from the base 110.

To allow the buffer tray assembly 200 to be easily removed from, and attached to, the base 110, the base 110 and buffer tray assembly have cooperating mating features. In the embodiment of FIG. 2, the buffer tray assembly 200 includes a footing 210 defining a rail slot 213. The rail slot 213 is shaped to receive a corresponding mating rail 113 on the base 110 of the microtome 100. The mating rail 113 may, in cross-section, have any of a variety of cross-sectional shapes 114, such as rectangular (FIG. 1E), trapezoidal (FIG. 1F), or rounded (e.g., circular or oval, FIG. 1G). In preferred embodiments, the buffer tray receptacle 203 is separable from the footing 210, so that the buffer tray receptacle 203 can be removed from the footing 110 so that each of the footing 110 and buffer tray receptacle 203 may be easily cleaned. Moreover, the footing 110 and the buffer tray receptacle 203 may be made of different materials, so separability allows each to be easily replaced, or repaired according to techniques required for the material from which it is made, and thereby to avoid having to discard one of those structures if the other breaks.

In preferred embodiments, the rail slot 213 is shaped to slide onto and off of the rail 113, so that the buffer tray assembly 200 is slidably installable onto, and slidably removable from, the base 110. To that end, the rail slot 213 preferably has a shape that is complementary to the cross-section 114 of the rail 113. For example, in some embodiments the rail slot and rail 113 male and female, and in some embodiments, the rail slot 213 dovetails with the rail 113. Some embodiments of the buffer tray assembly 200 also include a leg 202 to assist in supporting the buffer tray assembly 200.

Preferred embodiments also include a fastening system to secure the buffer tray assembly 200 into position on the base 110 so that a specimen holder 160 is disposed to engage the plunger 186, and the specimen 150 is disposed within the slicing window 101. FIG. 2 schematically illustrates a fastener aperture 214 that passes through the footing 210. The fastener aperture 214 is configured to receive, and pass through the footing 210, a fastener 215. The fastener 215 may be, for example, a bolt, thumb screw, or pin, to name but a few examples. Some embodiments attach the tray assembly 200 to the base 110, with or without a mating rail 113, using one or more fasteners 215 coupling to a corresponding number of fastener receivers 115.

The base 110 includes a fastener receiver 115 disposed to receive the fastener 215 and thereby secure the buffer tray assembly 200 to the base 110. In some embodiments, the fastener receiver 115 is a cavity into which the fastener enters. In some embodiments, the fastener receiver is a threaded cavity, to receive a threaded fastener 215, such as a bolt, screw or thumbscrew.

Some embodiments described above may be described as an apparatus for cutting a slice from a specimen with a blade, the apparatus having a base defining a plane; a blade holder movably mounted to the base so as to move the blade along a slicing path, the slicing path being diagonal relative to the plane; and a buffer tray removably attached to the base and disposed to receive the slice cut from the specimen by the blade. In some embodiments, the buffer tray is slidably attached to the base, and more particularly, the buffer tray is slidably attached to the base by a tray rail.

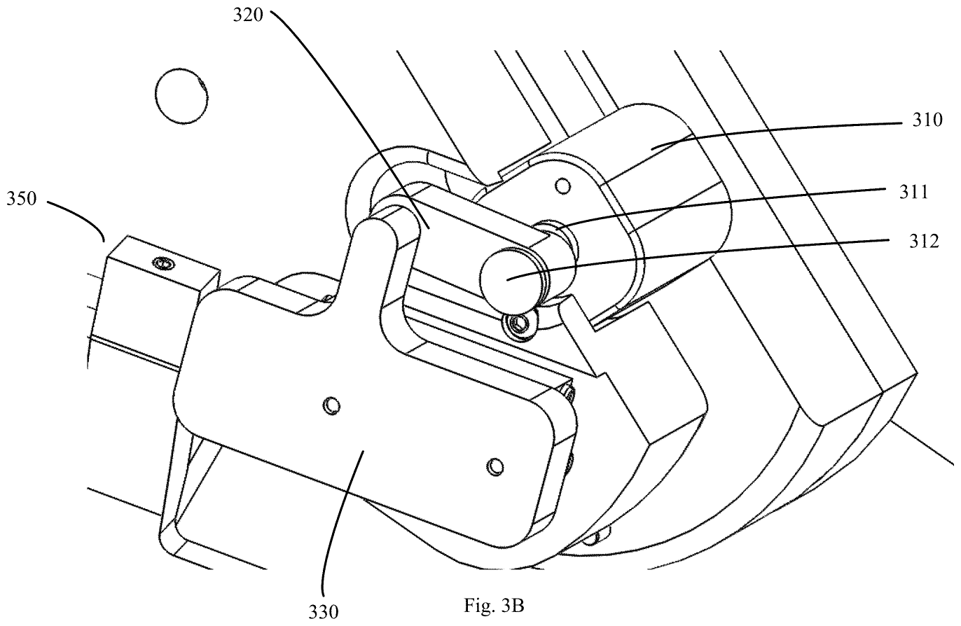

FIG. 3A and FIG. 3B schematically illustrate a blade drive system 300. In operation, the blade drive system 300 causes the edge 106 of the blade 105 to reciprocate. In preferred embodiments, the cutting edge 106 of the blade 105 is a linear edge, and the cutting edge reciprocates linearly along a line defined by the length of that edge 106. Such reciprocation may be referred to as “longitudinal” reciprocation (or longitudinal reciprocating motion).

The blade drive system 300 includes a blade drive motor 310 fixed to the cutting arm 141. The blade drive motor 310 includes a rotatable shaft 311, to which is attached a rotating member 312, which may be referred to as an “eccentric.”

A link 320 is coupled to the eccentric 312 such that the link 320 moves reciprocates as the eccentric 312 is driven by the blade drive motor 310.

A transmission arm 330 is coupled to an end of the link 320 distal from the eccentric 312, and a blade holder assembly 350 is coupled to the transmission arm, such that the blade holder assembly 350 reciprocates with the motion of the link 320. In other words, the link 320 and transmission arm 330 are disposed between the eccentric 312 and the blade holder assembly 350, so that when the blade drive motor 310 causes the link 320 to reciprocate, the link 320 and transmission arm 330 cause the blade holder assembly 350 to reciprocate, and the blade holder assembly 350 causes a blade 105 in the blade holder 360 to reciprocate. As such, the blade holder 360 may be described as being reciprocatingly coupled to the slicer arm 141.

In preferred embodiments, the link 320 is rigid, and may be made of a rigid plastic or nylon, to name but a few examples. The inventors have discovered that a rigid link 320 improves the performance of a microtome 100, relative to prior art devices that had flexible links (such as spring steel links), in that a rigid link 320 reduces unwanted vibrations in the blade 105. For example, a non-rigid link may drive a blade to move not only in a desired direction, but also to move in directions that are not aligned with the desired direction (e.g., motion that is not linear along a line defined by the length of the blade edge 106). Blade motion that is not aligned with the desired direction of blade edge reciprocation is undesirable in that it increases the risk of ragged, uneven cuts in the specimen 150 and slice 152.

FIG. 4A and FIG. 4B schematically illustrate an approach of a blade holder 360, and the blade 105 in the blade holder 360, to a specimen 150.

In illustrative embodiments, the edge 106 of the blade 105 forms a non-zero angle 351 relative to the plane 112 defined by the base 110. This angle may be referred to as a blade approach angle 351, in that this is the angle at which the edge 106 of the blade approaches the specimen 150. This is in contrast to prior art devices known to the inventors, in which the edge 106 of the blade 105 was held parallel to the base 110, or plane 112 defined by the base 110. In preferred embodiments, the approach angle 351 remains constant (fixed) throughout the motion of the slicing arm 141 along the slicing path 500.

The inventors discovered that a non-zero blade approach angle provides an advantage over prior art devices with respect to slicing a given specimen with a given blade. A non-zero blade approach angle 351 allows the blade 105 to slice through the given specimen in less time, and/or to slice through a larger specimen in the same amount of time.

In preferred embodiments, the blade approach angle 351 is 14 degrees, but in other preferred embodiments the approach angle 351 may be 11 degrees. 12 degrees, 13 degrees, 15 degrees, 16 degrees, or 17 degrees. In other embodiments the approach angle 351 may be any angle within the range of 5 degrees to 45 degrees, inclusive.

FIG. 5 schematically illustrates a slicing path taken when the microtome slices a specimen, and an alternate view of a blade approach angle.

As the slicing arm 141 moves from an upward position (at time T1) to a downward position (at time T2), the blade holder 360 (and a blade 105 held in the blade holder 360) follows a slicing path 500 indicated by a long dashed arrow extending from diagonally downward across the figure. The slicing path 500 is preferably linear, and forms an angle in the X-Z plane relative to the plane 112 defined by the base 110 (in other words, the slicing path 500 is not parallel to the base 110). In preferred embodiments, the slicing path 500 is diagonal relative to the plane 112, but in some embodiments may be parallel to the plane 112, or perpendicular to the plane.

As shown in FIG. 5, the line 510 defined by the edge 106 of the blade 105 forms an angle 520 (which may be referred to as the “edge angle”) with the slicing path 500. In preferred embodiments, the edge angle 520 remains constant (fixed) throughout the motion of the slicing arm 141 along the slicing path 500.

In preferred embodiments, the edge angle 520 is within a range of plus or minus 45 degrees, inclusive from the slicing path 500. In other words, in such embodiments, the angle 520 formed by the slicing path 500 and the edge 106 of the blade 105 is, in some embodiments, 90 degrees (i.e., perpendicular to the slicing path 500), but in illustrative preferred embodiments is 15 degrees. In other preferred embodiments, the edge angle 520 may be any angle within the range of 10-20 degrees, inclusive (i.e., 10 degrees, 11 degrees, 12 degrees, 13 degrees, 14 degrees, 15 degrees, 16 degrees, 17 degrees, 18 degrees, 19 degrees, or 20 degrees). In other illustrative embodiments, the edge angel may be greater than 20 degrees an up to 90 degrees (for example: may be 45 degrees, 50 degrees, 60 degrees, 70 degrees, 80 degrees, 90 degrees) or greater than 90 degrees up to 135 degrees (e.g., 91 degrees, 100 degrees, 110 degrees, 120 degrees, 130 degrees, or 135 degrees, to name but a few examples), provided that blade edge 106 is not parallel to the base 110 or the plane 112 defined by the base.

The travel of the blade 105 (or blade holder 360) down the slicing path 500 defines the slicing window 101. In illustrative embodiments, the slicing window 101 is a parallelogram in which two edges are defined by lines parallel to the edge 106 of the blade. The slicing window preferably is a two-dimensional space perpendicular to the plane 112 (i.e., parallel to the X-Z plane) in the figures, although in other embodiments the slicing window need not be perpendicular to the plane 112. The slicing window 101 represents and area through which the blade edge 106 will cut when the slicing arm 141 traverses the slicing path 500. In other words, a specimen 500 that extends through the slicing window 101 will be sliced when the blade 150 traverses the slicing window 101. Such a slicing window 101 is schematically illustrated by dashed lines in FIG. 4B.

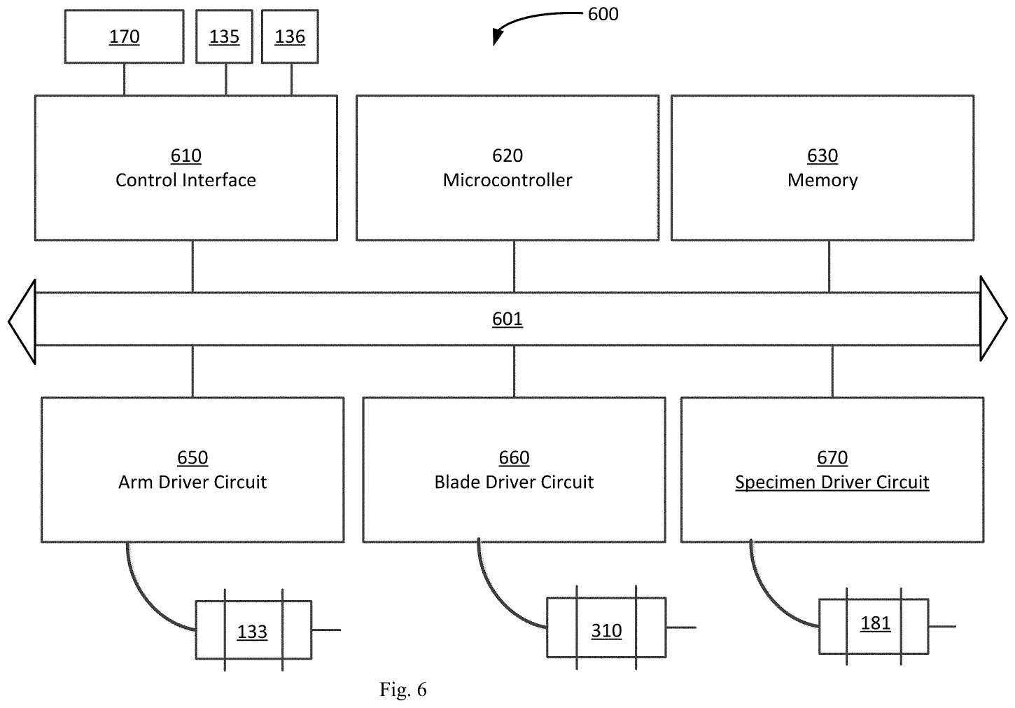

FIG. 6 schematically illustrates a control system 600 for controlling the operations of the microtome 100.

The control system 600 includes control interface 610 in electrical communication with the operator interface 171 and sensors 135 and 136. The control interface 610 receives input from the operator interface 171, and if the operator interface 171 includes a display screen 172, the control interface 610 provides data for display on the display screen 172.

The control system 600 also includes several motor driver circuits, including an arm driver circuit 650 operably coupled to the arm drive motor 133. The arm driver circuit 650 controls the arm drive motor 133 to move the slicing arm 141 down the guide rail 132 towards the specimen 150, and after the slicing is complete (e.g., at time T2, and/or when sensor 136 indicates that the slicing arm has reached the end of the slicing path 500), the arm driver circuit 650 causes the slicing arm to retract to its top position (at time T3 in FIG. 5, and/or when the sensor 135 indicates that the slicing arm 141 has reached that position).

The blade driver circuit 660 controls the blade driver motor 310 to cause the blade holder 360 to reciprocate, and thereby causes the blade 105 to reciprocate, as described above. The blade drive circuit 660 may control the blade driver motor 310 to operate continuously, or only when the slicing arm 141 is moving down the slicing path 500, and not when the slicing arm 141 is retracting.

The specimen driver circuit 670 controls the specimen driver motor 181 to advance the specimen holder 160, to move the specimen 150 into position to be cut by a blade 105, as described above.

The control system 600 also includes a microcontroller 620 for processing data received by the control interface 610, providing display data to the control interface 610 for display by the operator interface 170, and for coordinating the operation of the motor driver circuits 650, 660 and 670. To that end, the microcontroller may execute instructions stored in memory 630.

The circuits of the control system 600 are in data and control communication over bus 601.

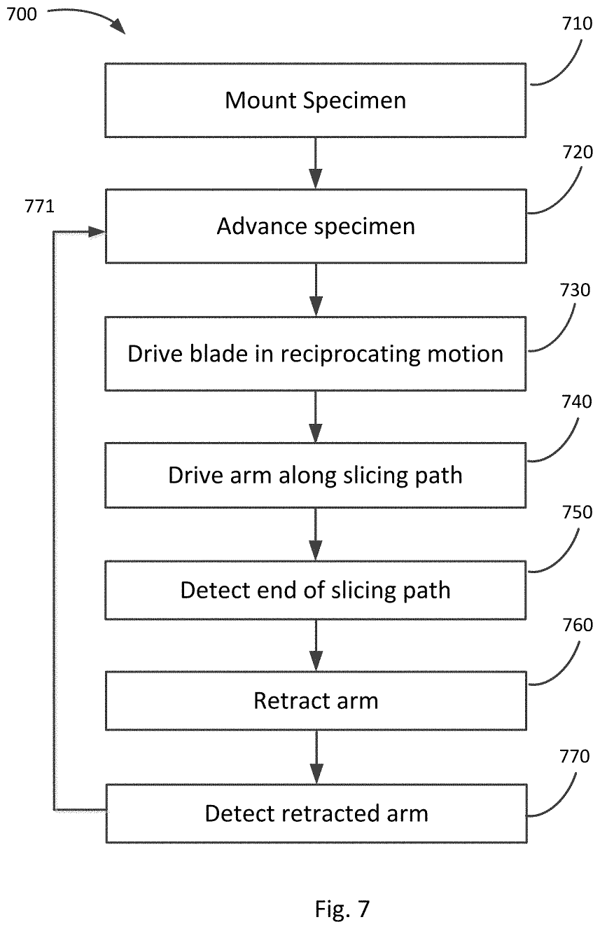

FIG. 7 is a flow chart of a method 700 of operating the microtome 100.

At step 710, an operator mounts a specimen 150 into the microtome 100. The specimen 150 is placed into a specimen holder 160, and mounted into the tray assembly 200, as described above.

At step 720, the specimen is advanced such that the face 151 of the specimen 150 is in position to be cut by the blade 105.

At step 730, the method 700 drives the blade 150 in a reciprocating motion, and at step 740, the method 700 drives the slicing arm 141 along the slicing path 500. In illustrative embodiments, the microtome 100 is configured so that the driving of the blade 105 (e.g., in a reciprocating motion) is independent of the drive of the slicing arm 141 along the slicing path 500. In other words, the blade 105 may be driven to reciprocate even though the slicing arm 141 is stationary, and/or the slicing arm 141 may be driven in either direction along the slicing path 500 even though the blade 105 is not being driven to reciprocate.

At step 750, the sensor 136 detects the position of the slicing arm 141 at the end of its travel down the slicing path 500. Subsequently, at step 760 the method 700 retracts the slicing arm 141, until at step 770 sensor 135 detects that the slicing arm has arrived at its top position.

Optionally, the process may loop, at step 771, to again advance the specimen at step 720. In some embodiments, the method loops through steps 720-770 to cut a plurality of slices 152 from the specimen 150, without repeated operator intervention. In such embodiments, the control system 600 may control the motion of the slicing arm 141, reciprocation of the blade 105, and advancement of the specimen 150, according to a pre-defined program stored in memory 630, or for a number of cycles set by an operator using the operator interface 171.

### REFERENCE NUMBERS USED HEREIN INCLUDE

100: Microtome;
101: Slicing window 101;
105: Blade;
106: Longitudinal blade edge (cutting edge);
110: Base;
111: Base top surface;
112: Plane;
113: Tray rail;
114: Tray rail shape in cross-section;
115: Fastener receiver;
120: Support structure (or superstructure);
130: Slicer assembly;
131: Arm support plate;
132: Slicer arm guide rail;
133: Slicer arm drive motor;
134: Slicer arm drive motor pinion;
135: Top sensor;
136: Bottom sensor;
141: Slicer arm;
150: Specimen;
151: Face of specimen;
152: Slice from specimen;
160: Specimen tube;
170: Control box;
171: Control interface (operator interface);
172: Control interface display;
173: Control interface controls (e.g., buttons/knobs/switches);
180: Specimen actuator system;
181: Specimen actuator drive motor;
184: Micrometer;
186: Specimen actuator shaft (plunger);
190: End of actuator shaft;
200: Buffer tray assembly;
201: Specimen aperture in buffer tray;
202: Leg;
203: Buffer tray receptacle;
210: Footing;
213: Rail slot;
214: Fastener aperture
215: Fastener;
250: Specimen block
251: Retaining aperture;
300: Blade driver system;
310: Blade drive motor;
311: Blade drive motor shaft;
312: Eccentric;
315: Point of rotation;
316: Point of link connection;
320: Link;
330: Transmission arm;
350: Blade assembly;
351: Approach angle
360: Blade holder;
500: Slicing path;
510: Longitudinal direction;
520: Edge angle (relative to slicing path);
600: Control system;
601: Bus;
610: Control interface;
620: Computer processor;
630: Memory;
650: Arm driver circuit;
660: Blade driver circuit;
670: Specimen driver circuit;

Various embodiments of the invention may be implemented at least in part in any conventional computer programming language. For example, some embodiments may be implemented in a procedural programming language (e.g., “C”), or in an object oriented programming language (e.g., “C++”). Other embodiments of the invention may be implemented as preprogrammed hardware elements (e.g., application specific integrated circuits, FPGAs, and digital signal processors), or other related components.

In an alternative embodiment, the disclosed apparatus and methods may be implemented as a computer program product for use with a computer system. Such implementation may include a series of computer instructions fixed on a tangible medium, such as a non-transient computer readable medium (e.g., a diskette, CD-ROM, ROM, FLASH memory, or fixed disk). The series of computer instructions can embody all or part of the functionality previously described herein with respect to the system.

Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies.

Among other ways, such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). Of course, some embodiments of the invention may be implemented as a combination of both software (e.g., a computer program product) and hardware. Still other embodiments of the invention are implemented as entirely hardware, or entirely software.

The embodiments of the invention described above are intended to be merely exemplary; numerous variations and modifications will be apparent to those skilled in the art. All such variations and modifications are intended to be within the scope of the present inventions as defined in any appended claims.

1. An apparatus for cutting a slice from a specimen with a blade having a longitudinal blade edge, the apparatus comprising:
a base defining a plane;
a blade holder movably mounted to the base so as to move the blade along a slicing path, the blade holder disposed such that the longitudinal blade edge forms, relative to the plane, a non-zero angle;
a drive motor operably coupled to the blade holder to drive the blade holder along the slicing path;
a buffer tray assembly removably attached to the base and disposed to receive slices cut from the specimen by the blade; and
a micrometer nonmovably mounted to the base.

2. The apparatus of claim 1, wherein the blade holder is disposed such that the longitudinal blade edge forms, relative to the plane, a fixed angle of at least 14 degrees.

3. The apparatus of claim 1, wherein the blade holder is disposed such that the longitudinal blade edge forms, relative to the slicing path, a fixed angle between 10 degrees and 20 degrees.

4. The apparatus of claim 1 further comprising:
a blade drive system operably coupled to the blade holder, such that the blade drive system is configured to drive the longitudinal edge of the blade in a longitudinal reciprocating motion.

5. The apparatus of claim 4, wherein the blade drive system is configured to drive the longitudinal edge of the blade in a longitudinal reciprocating motion independently of a passage of the blade holder along the slicing path.

6. The apparatus of claim 1, further comprising:
a superstructure extending from the base;
a slicer arm movably coupled to the superstructure, the blade holder reciprocatingly coupled to the slicer arm, such that the blade holder is movably mounted to the base.

7. The apparatus of claim 6, further comprising:
an arm guide coupled to the superstructure; and
an arm drive motor operably coupled between the superstructure and the slicer arm, and configured to urge the slicer arm along the arm guide.

8. (canceled)

9. The apparatus of claim 1, wherein the buffer tray assembly is removably attached to the base by cooperating mating features.

10. The apparatus of claim 1, wherein the buffer tray assembly comprises a specimen block configured to secure a specimen holder in position such that the specimen holder is disposed to deliver a specimen into a slicing window of the apparatus.

11. The apparatus of claim 10, wherein the specimen block defines a retaining aperture shaped to receive and slidably retain the specimen holder, such that the retaining aperture holds the specimen steady as the apparatus cuts a slice from the specimen, but also allows the specimen holder to advance through the retaining aperture when urged to do so.

12. The apparatus of claim 1, further comprising:
an eccentric rotatably coupled to the drive motor; and
a rigid link operably coupled between the eccentric and the blade holder to transform rotary motion of the motor to reciprocating motion of the blade holder.

13. The apparatus of claim 12, wherein the slicing path is diagonal relative to the plane.

14. The apparatus of claim 12, wherein the rigid link is a rigid plastic link.

15. The apparatus of claim 1, wherein the blade holder is disposed such that the longitudinal blade edge forms, relative to the plane, an angle of at least 30 degrees.

16. The apparatus of claim 1, wherein the blade holder is disposed such that the longitudinal blade edge forms, relative to the slicing path, an angle between 45 and 90 degrees.

17. The apparatus of claim 1, further comprising a control box, the control box comprising a control system in control communication with the blade drive motor to control the operation of the blade drive motor.

18. The apparatus of claim 17, wherein the control box comprises the micrometer and wherein the micrometer is disposed to urge the specimen into a slicing window of the buffer tray assembly.

19. A method of operating a microtome, comprising:
providing a microtome having a base, the base having a cutting arm movably coupled to the base, and a blade holder coupled to the cutting arm, the base further having a micrometer nonmovably coupled to the base, the blade holder configured to hold a cutting blade having a cutting edge;
providing a specimen extending through a slicing window;
moving the cutting edge in a longitudinal reciprocating motion; and
moving the cutting arm along a slicing path such that the blade traverses the slicing window.

20. The method of claim 19, further comprising: after moving the cutting arm along the slicing path, retracting the slicing arm and, by the micrometer, advancing a face of the specimen into the slicing window.
